(19) United States
(12) Patent Application Publication
(10) Pub. No.: US 2007/0273976 A1
(43) Pub. Date: Nov. 29, 2007

(54) Optical Device for Processing a Beam, in Particular a Laser Beam

(76) Inventors: Bernd Ozygus, Berlin (DE); Juergen Erhard, Berlin (DE)

Correspondence Address: KENYON & KENYON LLP, ONE BROADWAY, NEW YORK, NY, 10004, US

(21) Appl. No.: 11/547,321

(22) PCT Filed: Feb. 28, 2005
(86) PCT No.: PCT/EP05/50851

§ 371 Date: Jul. 30, 2007

(30) Foreign Application Priority Data
Apr. 1, 2004 (DE) 10 2004 016 835.0

(51) Int. Cl. G02B 27/09

(52) U.S. Cl. 359/641; 359/831

(57) ABSTRACT

An optical device is used for processing a laser beam. It includes an optical element into which at least one input beam is coupled and out of which an output beam emerges. It is proposed that the optical element include a transparent member which has two mutually opposing surfaces having an intermediate plane, which is oriented in such a way that it subtends a first angle with a first spatial axis disposed orthogonally to the longitudinal axis of the input beam, and a second angle with a second spatial axis disposed orthogonally to the longitudinal axis of the input beam and to the first spatial axis, each of these being greater than zero; an that an incoupling prism for coupling the input beam into the member is provided at the one surface, and an outcoupling prism for coupling the output beam out of the member is provided at the opposite surface of the member; viewed in the direction of the longitudinal axis of the input beam, the incoupling prism and the outcoupling prism covering different regions on the member.

### FIELD OF THE INVENTION

The present invention relates to an optical device for processing a beam having a flat cross section into a beam having a less flat cross section, in particular a laser beam, having at least one optical element into which at least one portion of the beam is coupled as an input beam and out of which at least one portion of the beam emerges as an output beam.

### BACKGROUND INFORMATION

The radiation from laser diodes is generally highly astigmatic. This means that, in both spatial directions, the dimension of the radiation source differs, as does the radiation angle of the light. This generally yields beam cross sections which are very substantial in width in comparison to height. For that reason, the radiation from laser diode bars in particular, is not able to be directly coupled into an optical fiber. Therefore, efforts are directed to processing the beam in a way that results in a most symmetrical possible cross section, by reducing the width and increasing the height. An ideal radiation field would be as precisely wide as it is high and have the same divergence angles in both directions. To achieve or at least come close to achieving this goal, “restacking methods” are used. These methods provide for shifting regions of the radiation field of an input beam in such a way that the output beam produced has at least a more or less desired intensity distribution.

From the European Published Patent Application No. 0 731 932, it is known, for example, to arrange two mirrors in parallel to one another and at a certain distance from one another. In addition, the two mirrors are slightly offset from one another. One small region of the radiation field bypasses the two mirrors without being reflected by the same. The larger portion of the radiation field is reflected back and forth between the two mirrors until it emerges in a specific region from the interspace therebetween. The disadvantage associated with this device is the substantial requisite outlay for the mirrors and the mounting thereof and the considerable adjustment requirements.

From the European Published Patent Application No. 0 863 588, a device is known which employs a plate fan. In this connection, the beam offset is utilized during passage of the beam through a plurality of plane-parallel plates. The angle between the beam direction and the surface of the plate inside and outside of the plate is dependent on the refractive index of the plate material. The higher the refractive index of the material, the greater is the deviation of the two angles. Since the plate has parallel side surfaces, the beam does not experience any change in direction after passing through the plate, rather only a parallel lateral shift. For the most part, two plate fans, which are rotated by 90° with respect to each other, are used. Here as well, the manufacturing costs are comparatively high and the precise adjustment of the plate fans is complex.

Also known from the German Published Patent Application No. 199 01 500 is a beam-shaping optical system having an optical element which, on its incident side, has surfaces that are inclined towards each other and are each assigned to a parallel surface on the emergent side. The optical principle is similar to that of the plate fan described above.

### SUMMARY OF THE INVENTION

The object of the present invention is to further refine a device of the type mentioned at the outset in such a way that it will be able to be manufactured and used less expensively.

This objective is achieved by a device of the type mentioned at the outset in that
a. the optical element includes a member that is at least transparent to the wavelengths of the beam;
b. the two opposing surfaces have an intermediate plane which is oriented in such a way that it subtends a first angle with a first spatial axis disposed orthogonally to the longitudinal axis of the input beam, and a second angle with a second spatial axis disposed orthogonally to the longitudinal axis of the input beam and to the first spatial axis, each of these being greater than zero; and
c. an incoupling prism for coupling the input beam into the member is provided at the one surface, and an outcoupling prism for coupling the output beam out of the member is provided at the opposite surface thereof;
d. viewed in the direction of the longitudinal axis of the input beam, the incoupling prism and the outcoupling prism cover different regions on the member.

The device according to the present invention is able to be manufactured very economically since, instead of mirrors or thin and fan-shaped plates, one single transparent (for example pellucid) member is simply used, which is geometrically tilted and rotated relative to the longitudinal axis of the input beam in such a way that light beams coupled into the same are totally internally reflected by the opposing surfaces, and regions of the beam are “restacked.” Suitable prisms, which may likewise be simply manufactured, are used for coupling in and coupling out the light beam. Thus, to process the beam, at most, only three elements are still needed. Moreover, mutual and geometrically simple adjustments are able to be easily performed on these elements. Thus, the costs to be expended for beam processing, in particular when working with laser diodes, are substantially reduced by the device according to the present invention.

The physical effect employed by the present invention is the total internal reflection within an “optically dense” medium, in which light, which is passing through inside of a member that has a higher refractive index than the medium (for example air) surrounding it, undergoes a total internal reflection within specific limiting angles. The rotation and tilting of the intermediate plane of the member relative to a plane disposed normally to the input beam, as well as the distance between the two mutually opposing surfaces determine the type and the extent of the restacking.

In this context, the rotation of the intermediate plane about an axis disposed normally to the plane of the input beam causes regions of the radiation field to be displaced in the direction of the plane of the input beam (“slow axis”), whereas the tilting of the intermediate plane about an axis which is disposed normally to the longitudinal axis of the input beam and resides in the plane of the input beam yields a certain “thickness” of the output beam. By positioning the incoupling prism and the outcoupling prism in different regions of the optical member, viewed in the direction of the longitudinal axis of the input beam, exposed regions result on both mutually opposing surfaces of the member, so that, in these regions, the radiation coupled into the member may undergo total internal reflection, as desired by the present invention. It this context, it is understood that the different regions may also overlap.

Advantageous further refinements of the present invention are delineated in the dependent claims.

One first especially-preferred embodiment has the distinguishing feature that the mutually opposing surfaces of the optical member are at least essentially plane-parallel and flat. Fundamentally, the result is a flat plate or a flat square, which is especially simple to manufacture. Moreover, in the context of plane-parallel surfaces which produce the total internal reflection of the radiation, the path of the radiation is readily determinable in advance.

It is especially preferred when the angle between the intermediate plane and the first spatial axis is within the range of 40° to 50°, and the angle between the intermediate plane and the second spatial axis within the range of 5° to 60°, in particular within the range of 30° to 40°, the first spatial axis residing in the plane of the input beam. Most notably, such angles make possible a very efficient processing of the input beams produced by laser diode bars, while simultaneously allowing for small dimensions of the device and easy and thus also economical producibility.

Another advantageous embodiment of the optical device according to the present invention has the distinguishing feature that the incoupling prism is located in the region of a longitudinal edge of the member that is most proximate to the input beam, and the outcoupling prism in the region of a side edge of the member that is the most remote from the input beam. In this configuration, the light beam is processed using the least possible amount of total internal reflections, thereby enhancing the beam quality.

The optical device may be produced by joining the incoupling prism and/or the outcoupling prism to the member using an optical cement. This enables the incoupling prism, the outcoupling prism, and the member to be manufactured as separate elements that may be assembled as a modular system in conformance with the individual usage requirements. It is conceivable, for example, to manufacture different sets of incoupling prisms, outcoupling prisms, and members and then to combine them with one another in any desired manner. This allows optimal results to be achieved under very different operating conditions and at low costs. As a cement, a material is suited whose refractive index corresponds as precisely as possible to that of the member and of the prisms. An example of such a material is a UV-hardening adhesive.

Alternatively, it is possible for the incoupling prism and/or the outcoupling prism to be integrally formed in one piece with the member and preferably of the same material as the member. The thus realized integral one-piece design of the optical device facilitates handling during installation and reduces the risk of optical losses when the beam is coupled into and out of the member. In addition, the need is eliminated for separate installation elements.

The optical device according to the present invention may be manufactured very economically when the member, the incoupling prism, the outcoupling prism or the one-piece unit including at least two of the former elements are, respectively is, manufactured as an injection-molded part, preferably of plastic.

In addition, it is especially advantageous when a collimating device is optically connected to the incoupling prism or is integrated in the same and/or when a focusing device is optically connected to the outcoupling prism or is integrated in the same. In such a case, the optical device not only assumes the “restacking” function, but also the collimation of the fast axis, in particular, and/or the coupling of the beam into an optical fiber, for example. Thus the need is eliminated for separate devices which fulfill these tasks, thereby further reducing the manufacturing costs.

To this end, one practical embodiment proposes that the focusing device include a toroidally curved emergent face on the outcoupling prism. This results in a toroidal lens that is integrally formed in one piece with the outcoupling prism and that has different focal lengths for the two spatial directions. These unequal focal lengths are essential since the divergence angles are distinctly different for the two spatial directions, especially in the context of laser radiation. A toroidally curved emergent face on the outcoupling prism may be realized simply and economically.

The focusing device may optionally include a light concentrator which is connected to the outcoupling prism, is designed as a monolithic component, and which focuses the radiation by way of the plurality of total internal reflections at its outer limiting surfaces. Such a focusing device, also described as a “lens duct”, may likewise be manufactured very simply. The dimensions of the light concentrator must be adapted to the focusing requirements of the light beam. In most cases, it is necessary to reduce the width of the radiation field for both spatial directions. To this end, the outer surfaces of the light concentrator, where the total internal reflections take place, must be designed to be both plane as well as curved. The use of a light concentrator in the manner proposed advantageously eliminates the need for adjusting the fibers when coupling the light into an optical fiber. In the simplest case, the fibers may be adhesively bonded to the end of the light concentrator. This also economizes on the costs entailed in the manufacturing and assembling of the optical device.

It is also proposed that the collimating device include an incident face on the incoupling prism that is designed as a convexly curved lens. In this manner as well, a lens is produced which collimates the radiation in the direction of the fast axis. A lens of this kind has a very large acceptance angle, so that only an aspherical surface is suited.

The present invention also relates to a beam-shaping device for laser diode stacks. It is proposed that the device include a plurality of optical devices of the above type which are placed one over the other to form a stack. A beam-shaping device of this kind makes it possible for the radiation field from a stack of laser diode bars to be processed in a simple manner.

### BRIEF DESCRIPTION OF THE DRAWINGS

FIG. 1 shows a laser diode bar having an actual beam shape and a nominal beam shape.

FIG. 2 shows a perspective representation of a first specific embodiment of an optical device for processing the laser beam of FIG. 1 from an oblique rear view.

FIG. 3 shows-a perspective representation of the optical device of FIG. 2 from an oblique front view.

FIG. 4 shows a perspective detailed representation of an optical member of the optical device of FIG. 2.

FIG. 5 shows a perspective representation of a second specific embodiment of an optical device from an oblique front view.

FIG. 6 shows a perspective representation of the optical device of FIG. 5 from an oblique rear view.

FIG. 7 shows a perspective representation of an optical device according to FIG. 5, including a light concentrator.

FIG. 8 shows a schematic representation for clarifying the functional principle of the light concentrator of FIG. 7.

FIG. 9 shows a perspective representation similar to that of FIG. 6, of a third specific embodiment of an optical device.

FIG. 10 shows a perspective representation of a region of a fourth specific embodiment of an optical device.

FIG. 11 shows a perspective representation of a plurality of optical devices from an oblique front view, in accordance with a sixth specific embodiment. FIG. 12 shows a perspective representation of the stack from FIG. 11, from an oblique

### DETAILED DESCRIPTION

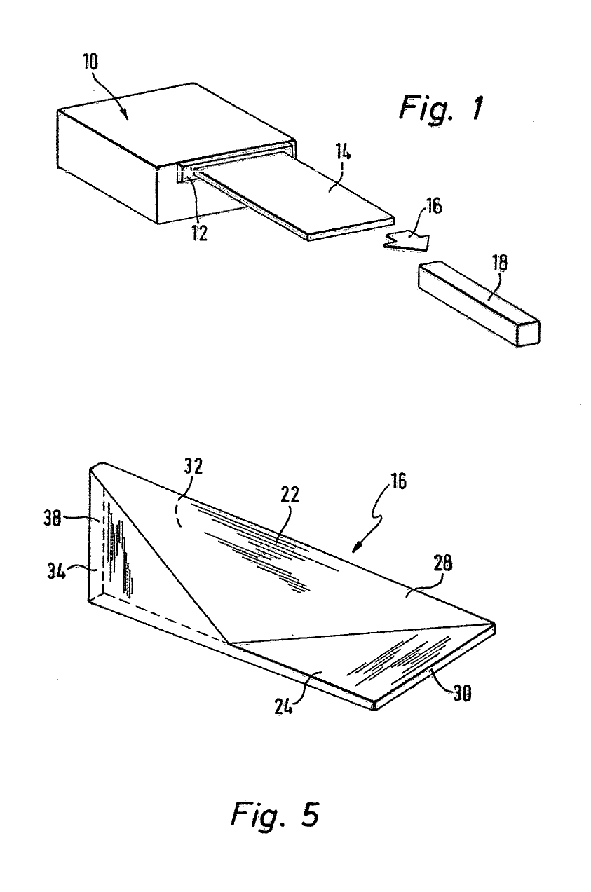

In FIG. 1, a laser diode bar is denoted as a whole by reference numeral 10. The laser beam emitted from this laser diode bar is collimated with the aid of a cylindrical lens 12 in the direction of the fast axis. The resulting laser beam 14 has a comparatively wide and flat cross-sectional shape, respectively a highly astigmatic intensity distribution. Using a suitable device, which is discussed in detail further below and is symbolized merely by an arrow 16 in FIG. 1, the intention is to symmetrize laser beam 14. This means that the output beam 18 emerging from optical device 16 is not as wide or flat as input beam 14. It is noted at this point that here and in the following a “beam” may also be understood to be a bundle of individual rays.

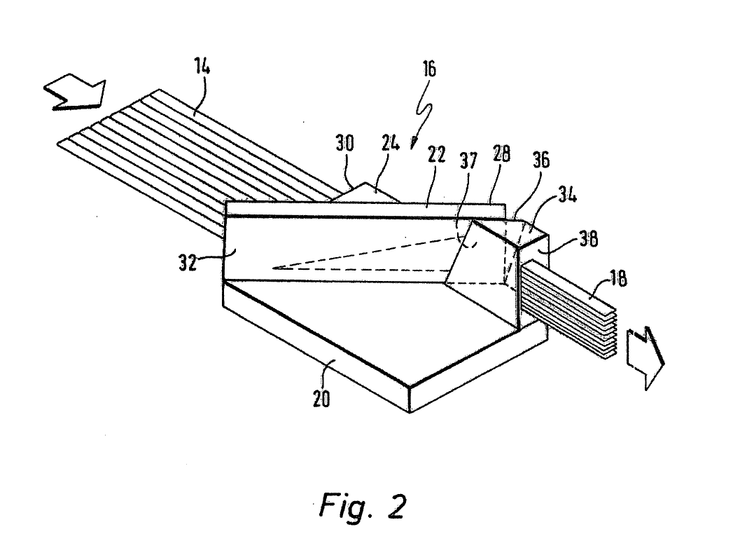

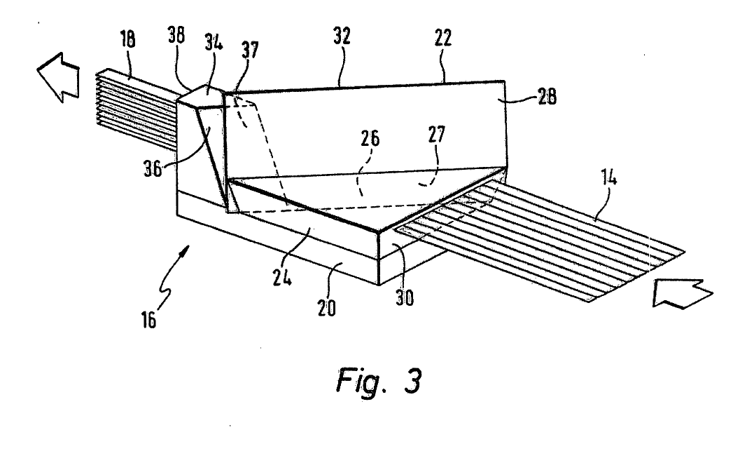

Optical device 16 is shown in greater detail in FIG. 2 and 3: It includes a base plate 20, whose plane is disposed substantially in parallel to the plane of input beam 14. A plate-shaped optical member 22 is mounted on base plate 20. It does not rest perpendicularly on base plate 20, but rather is tipped to the rear, viewed in the direction of input beam 14. In addition, optical member 22 is also rotated about an axis that is normal to the plane of input beam 14; thus it rests obliquely across base plate 20. The precise geometric orientation of optical member 22 is described further below.

Also mounted on base plate 20 is an incoupling prism 24, which has approximately the basic shape of a right-angled triangle and is laid flat on base plate 20. A hypotenuse face 26 of incoupling prism 24 (FIG. 3) is joined by an optical cement (not shown) to surface 28 of optical member 22 facing input beam 14 where it covers a region 27. In this context, incoupling prism 24 rests flat against front surface 28 of optical member 22 and, to be precise, in the area of the lower longitudinal edge thereof that is most proximate to input beam 14 in FIG. 2 and 3. Overall therefore, an incident face 30 of incoupling prism 24 that is formed by a cathetus surface is disposed normally to input beam 14.

Situated at a rear surface 32 of optical member 22 on base plate 20 is an outcoupling prism 34. It is designed as an irregular octagonal block. The side, top, and bottom surfaces of the outcoupling prism that are not provided with reference numbers are oriented on the whole in parallel to the axis of input beam 14 and also of output beam 18. A contact surface 36 facing optical member 22 has an oblique, respectively tipped form in the two spatial directions such that, following application of an optical cement, it rests, at least in some areas, flat on rear surface 32 of optical member 22 where it covers a region 37. An emergent face 38 of outcoupling prism 34 opposing contact surface 36, in turn, is disposed normally to the axis of output beam 18.

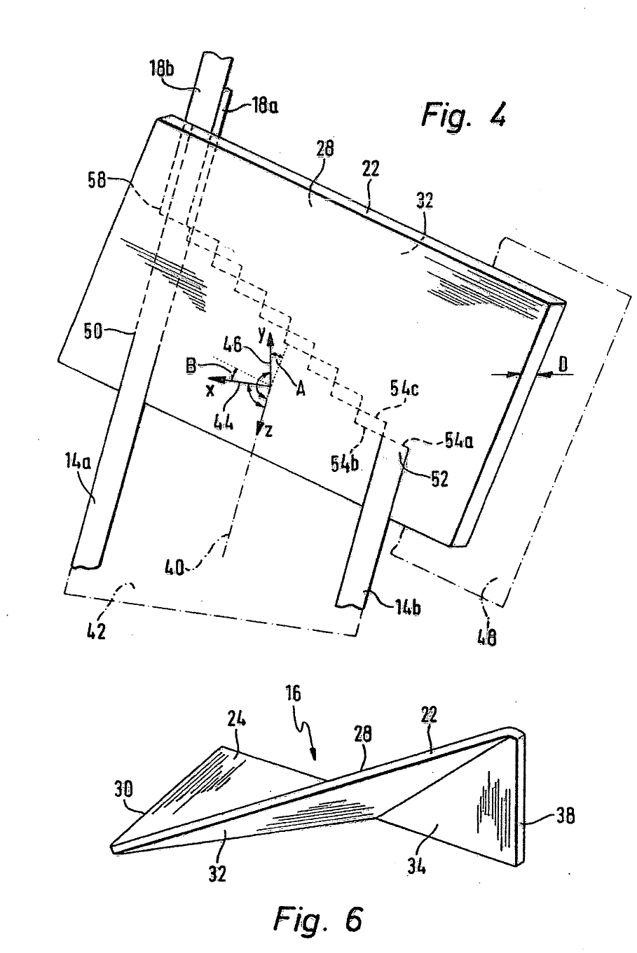

Incoupling prism 24, outcoupling prism 34, as well as plate-shaped optical member 22 are each fabricated as separate parts out of glass. The purpose of incoupling prism 24 is to couple input beam 14 into optical member 22. Analogously, outcoupling prism 34 has the function of coupling output beam 18 out of optical member 22. The actual processing or restacking of the laser radiation in a process involving a multiplicity of total internal reflections, is carried out in optical member 22. This is described with reference to FIG. 4: Of input beam 14, FIG. 4 shows only two outer regions having reference numerals 14a and 14b. One longitudinal axis of input beam 14 is indicated by a dot-dash line denoted by reference numeral 40. The plane of input beam 14 is marked by a dot-dash line and is denoted by 42. A first spatial axis X orthogonal to longitudinal axis 40 of input beam 14 is denoted by 44 and resides in plane 42 of the input beam. A second Y-axis disposed orthogonally to longitudinal axis 40 of input beam 14 is oriented normal to plane 42 of input beam 14 and is denoted by 46. Defined between the two surfaces 28 and 32 of optical member 22 is an intermediate plane 48 indicated by a dot-dash line in FIG. 4. As mentioned at the outset, this plane is tilted back by an angle A relative to Y-axis 46. It is also rotated by an angle B relative to X-axis 44. In the present exemplary embodiment, angle A is approximately 35°, angle B 45°. A thickness D of plate-shaped optical member 22 is uniform throughout and, in the present exemplary embodiment, is approximately 0.7 mm.

Use is made of the total internal reflection principle for beam processing within optical member 22. This means that light that is passing through inside of optical member 22, whose material has a higher refractive index that the medium (generally air) surrounding it, undergoes a total reflection at the exposed regions of surfaces 28 and 32, within specific limiting angles. On the other hand, at the unexposed regions of surfaces 28 and 32 of optical member 22, namely at region 27 covered by hypotenuse face 26 of incoupling prism 24 and at region 37 covered by contact surface 36 of outcoupling prism 34 (compare FIG. 2 and 3), no total internal reflection takes place, since incoupling prism 24, outcoupling prism 34, as well as optical member 22 are fabricated from the same material having the same refractive index.

One first considers the path of rays of partial beam 14a of input beam 14: This path of rays is coupled through incoupling prism 24 (not shown in FIG. 4) into optical member 22. However, regions 27 and 37 overlap in the area of a position 50. Thus, at rear surface 32 of optical member 22, input beam 41 a is not reflected, but rather coupled immediately via outcoupling prism 34 out of optical member 22. It emerges as partial beam 18b out of optical member 22 and finally out of outcoupling prism 34. In this context, partial output beam 18a has the same direction and position as partial input beam 14a.

Partial input beam 14b is likewise coupled via incoupling prism 24 into optical member 22. However, this occurs at a position 52 where rear surface 32 is exposed. Due to the inclined position of optical member 22 and thus also of rear surface 32, partial input beam 14b undergoes total reflection at a position 54a at the exposed rear surface 32. Due to the rotation of intermediate plane 48 and, as a result, also of two surfaces 28 and 32 by angle B about Y-axis 46, input beam 14b does not impinge normally on rear surface 32, but rather obliquely, and is therefore reflected laterally. Due to the tilting of intermediate plane 48 and, as a result, also of rear surface 32 by angle A about X-axis 44, partial input beam 14b is moreover reflected obliquely upwards relative to intermediate plane 48 at point of reflection 54a.

At 54b, partial input beam 14b again impinges on front surface 28 of optical member 22. This position is located outside of region 27 covered by hypotenuse face 26 of incoupling prism 24 on front surface 28 of optical member 22. Thus, partial input beam 14b is reflected, in turn, at position 54b in the direction of original axis 40 and then impinges again at 54c on rear surface 32 of optical member 22. Input beam 14b continues to be reflected back and forth in this manner within optical member 22 until it arrives in region 37 of rear surface 32 of optical member 22 covered by contact surface 36 of outcoupling prism 34. In this region, input beam 14b is coupled out of optical member 22 at position 58 and arrives in outcoupling prism 34. There, it emerges as partial output beam 18b from emergent face 38.

As is apparent from FIG. 2 through 4, the extreme right region 14b of input beam 14 is “restacked” as a result of the total internal reflection within optical member 22, so that it emerges from optical device 16 as partial output beam 18b above partial region 18a. The broad and flat input beam 14 is reshaped by optical device 16, which includes incoupling prism 24, optical member 22, and outcoupling prism 34, into a less broad and, therefore, distinctly thicker output beam 18b. It is understood that, in reality, input beam 14 does not have any discrete partial beams. This is not the case for output beam 18: It is actually made up of a stack of partial output beams 18a, 18b, . . . . The number of partial output beams and the spacing between them is set by plate thickness D, as well as by angles A and B.

In the following, other specific embodiments of optical devices 16 are described. In this context, those elements and regions, whose functions are equivalent to those of elements and regions of previously described exemplary embodiments, are denoted by the same reference numerals. They are generally not explained in detail again.

In the case of optical device 16 shown in FIG. 5 and 6, optical member 22, incoupling prism 24, as well as outcoupling prism 34 are designed as a one-piece monolithic unit. A base plate is not present in this specific embodiment. Optical device 16 shown in FIG. 5 and 6 is manufactured as a plastic injection molded part.

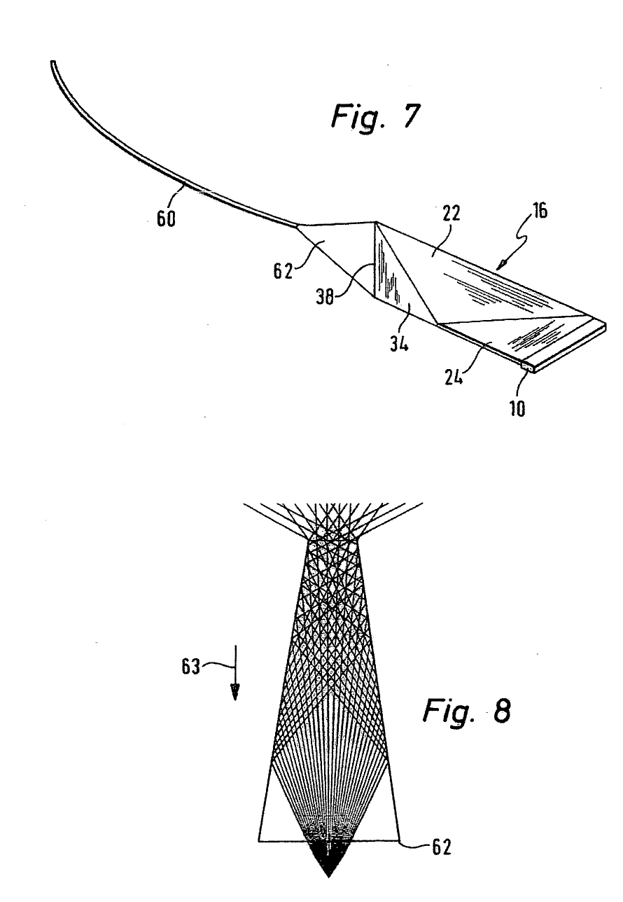

In addition to the restacking function, optical device 16 may also assume other functions, such as coupling the output beam into an optical fiber 60, in accordance with FIG. 7. To this end, fastened to emergent face 38 of outcoupling prism 34 is a focusing device 62, which, in the exemplary embodiment shown in FIG. 7, is designed as a light concentrator, also described as “lens duct.” The radiation is focused in the same by way of a plurality of total internal reflections at its exposed lateral surfaces. Optical fiber 60 is simply adhesively bonded to the end of light concentrator 62. The principle of such a light concentrator is shown in FIG. 8. An arrow 63 denotes the beam direction. The dimensions of light concentrator 62 must be adapted to the individual requirements of the particular operational case. In most cases, it is necessary to reduce the width of the radiation field for both spatial directions. The outside surfaces of the light concentrator shown in FIG. 8 have a straight-line design. However, they may also be curvilinear.

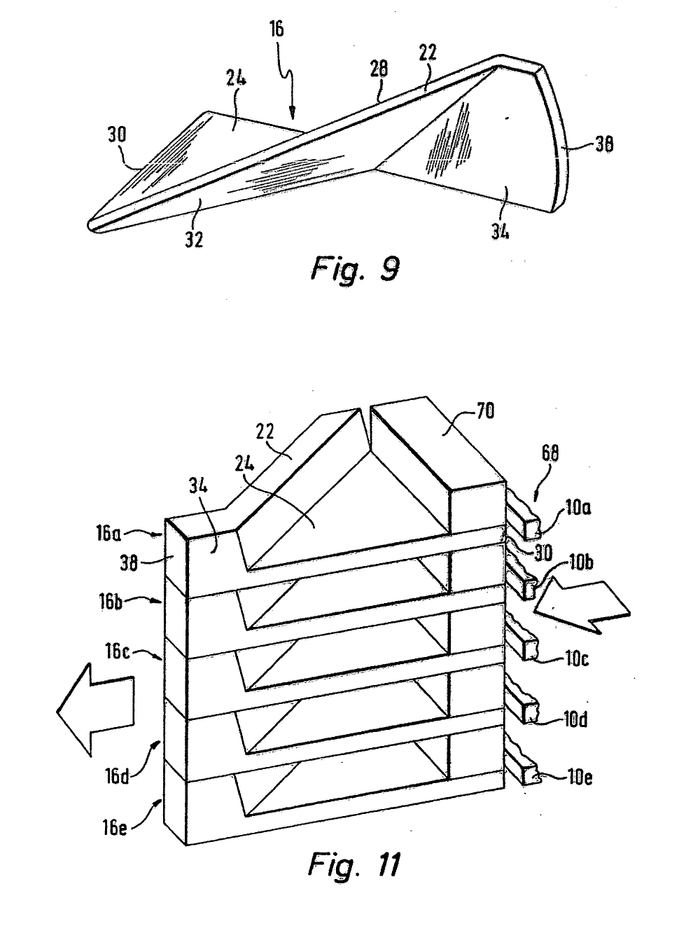

In the specific embodiment shown in FIG. 9, focusing device 62 is designed as a toroidal lens that is devised as a suitably curved form of emergent face 38 on outcoupling prism 34. In this manner, different focal lengths may be realized for both spatial directions. Such unequal focal lengths are essential, since the divergence angles of output beam 18 may be distinctly different for the two spatial directions.

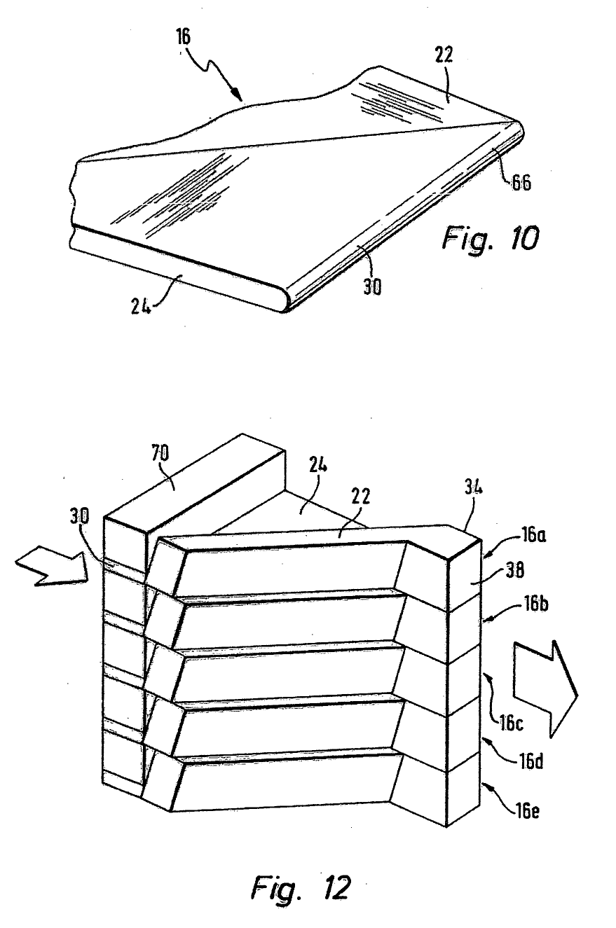

Another task that may be additionally assumed by the optical device is the collimation of the fast axis of input beam 14. To this end, incident face 30 on incoupling prism 24 is designed as an aspherical lens 66 in that it is convexly curved, as is apparent from FIG. 10.

To achieve high power densities, laser diode bars are also stacked in the manner of a laser diode stack. In the specific embodiment shown in FIG. 11 and 12, five laser diode bars 10a through e are stacked as a laser diode stack 68. Therefore, in the embodiment shown in FIG. 11 and 12, five optical devices 16a-16e are stacked one over another for purposes of beam shaping. It is clearly discernible that optical member 22 in optical devices 16 shown in FIG. 11 and 12 is distinctly lower in height than, for example, in the embodiment shown in FIG. 2 and 3. An oblong, rectangular spacer block 70 is set on each of incoupling prisms 24 to permit the individual optical devices 16a through 16e to be stacked with axial precision and in parallel. The configuration shown in FIG. 11 and 12 has the effect of dividing the radiation field of each laser diode bar 10a through 10e and of thereby stacking the individual radiation fields one over the other.

1-12. (canceled)

13. An optical device for processing a beam having a flat cross section into a beam having a less flat cross section, comprising:
at least one optical element into which at least one portion of the beam is coupled as an input beam and out of which at least one portion of the beam emerges as an output beam, wherein:
the at least one optical element includes a member that is at least transparent to a wavelengths of the beam,
the at least one optical element includes two opposing surfaces having an intermediate plane is oriented in such a way that it subtends a first angle with a first spatial axis disposed orthogonally to a longitudinal axis of the input beam, and a second angle with a second spatial axis disposed orthogonally to the longitudinal axis and to the first spatial axis, and
each of the first angle and the second angle is greater than zero;
an incoupling prism for coupling the input beam into the member and being provided at one of the two opposing surfaces; and
an outcoupling prism for coupling the output beam out of the member and being provided at a second one of the two opposing surfaces, wherein when viewed in a direction of the longitudinal axis of the input beam, the incoupling prism and the outcoupling prism cover different regions on the member.

14. The optical device as recited in claim 13, wherein the at least two opposing surfaces are at least substantially plane-parallel and flat.

15. The optical device as recited in claim 13, wherein:
the second angle between the intermediate plane and the first spatial axis is within a range of 40° to 50°,
the first angle between the intermediate plane and the second spatial axis is within a range of 5° to 60°, and
the first spatial axis resides in a plane of the input beam.

16. The optical device as recited in claim 13, wherein:
the incoupling prism is located in a region of a longitudinal edge of the member that is most proximate to the input beam, and
the outcoupling prism is located in a region of a side edge of the member that is most remote from the input beam.

17. The optical device as recited in claim 13, wherein at least one of the incoupling prism and the outcoupling prism is joined to the member via an optical cement.

18. The optical device as recited in claim 13, wherein:
at least one of the incoupling prism and the outcoupling prism is integrally formed in one-piece with the member, and
at least one of the incoupling prism and the outcoupling prism is made of the same material as the member.

19. The optical device as recited in claim 13, wherein one of the member, the incoupling prism, the outcoupling prism, and a one-piece unit including at least two of the member, the incoupling prism, and the outcoupling prism is manufactured as an injection-molded part made of plastic.

20. The optical device as recited in claim 13, further comprising at least one of:
a collimating device one of optically connected to and integrated in the incoupling prism; and
a focusing device one of optically connected to and integrated in the outcoupling prism.

21. The optical device as recited in claim 20, wherein the focusing device includes a toroidally curved emergent face on the outcoupling prism.

22. The optical device as recited in claim 20, wherein:
the focusing device includes a light concentrator connected to the outcoupling prism,
the focusing device is designed as a monolithic component, and
the focusing device focuses a radiation by way of a plurality of total internal reflections at outer limiting surfaces thereof.

23. The optical device as recited in claim 20, wherein the collimating device includes an incident face on the incoupling prism that is designed as a convexly curved lens.

24. A beam-shaping device for laser diode stacks, comprising:
a plurality of optical devices placed one over the other in order to form a stack and for processing a beam having a flat cross section into a beam having a less flat cross section, each optical device including:
at least one optical element into which at least one portion of the beam is coupled as an input beam and out of which at least one portion of the beam emerges as an output beam, wherein:
the at least one optical element includes a member that is at least transparent to a wavelengths of the beam,
the at least one optical element includes two opposing surfaces having an intermediate plane is oriented in such a way that it subtends a first angle with a first spatial axis disposed orthogonally to a longitudinal axis of the input beam, and a second angle with a second spatial axis disposed orthogonally to the longitudinal axis and to the first spatial axis, and
each of the first angle and the second angle is greater than zero;
an incoupling prism for coupling the input beam into the member and being provided at one of the two opposing surfaces; and
an outcoupling prism for coupling the output beam out of the member and being provided at a second one of the two opposing surfaces, wherein when viewed in a direction of the longitudinal axis of the input beam, the incoupling prism and the outcoupling prism cover different regions on the member.

25. The optical device as recited in claim 13, wherein the beam is a laser beam.

26. The optical device as recited in claim 13, wherein:
the second angle between the intermediate plane and the first spatial axis is within a range of 40° to 50°,
the first angle between the intermediate plane and the second spatial axis is within a range of 30° to 40°, and
the first spatial axis resides in a plane of the input beam.
